(19) United States
(12) Patent Application Publication
(10) Pub. No.: US 2003/0034900 A1
(43) Pub. Date: Feb. 20, 2003

(54) System and method for wireless automatic meter reading

(76) Inventor: Myoung Cook Han, Seoul (KR)

Correspondence Address: BACON & THOMAS, PLLC, 625 SLATERS LANE, FOURTH FLOOR, ALEXANDRIA, VA, 22314

(21) Appl. No.: 10/148,896

(22) PCT Filed: Dec. 18, 2000
(86) PCT No.: PCT/KR00/01489

(30) Foreign Application Priority Data
Dec. 21, 1999 (KR) 1999/60049
Nov. 30, 2000 (KR) 2000/72019

(51) Int. Cl. G08C 15/06

(52) U.S. Cl. 340/870.02

(57) ABSTRACT

A system and method for wireless automatic meter reading which can wirelessly and remotely read integrated amounts of consumed electric power, water, gas and the like. An image sensor module (1) is installed in a predetermined portion of an integrating meter for picking up an image of a numeral displayed on a display of the integrating meter and converting the picked-up image into an electrical signal. A main processor unit (7) generates a numeric code corresponding to the numeral image. A radio frequency module (13) transmits the generated numeric code wirelessly to a meter reading center (16).

### TECHNICAL FIELD

The present invention relates to a system and method for wireless automatic meter reading which cap wirelessly and remotely read integrated amounts of consumed electric power, water, gas and the like.

### BACKGROUND ART

Generally, metermen must personally read integrating meters such as electric power meters, gas meters, water meters, etc. to charge users rates for power consumption, gas consumption, water consumption, etc. Namely, a meterman has to check a numerical value of a given integrating meter with the naked eye record the checked value by hand, subtract a numerical value of the last month from the recorded value and issue a user a bill statement based on the resulting numerical value and an integrated amount-to-rate table.

This meter reading process has a disadvantage in that it requires a large amount of manpower leading to many expenses. Also, metermen may erroneously record numerical values of integrating meters, nobody may be present in visited houses, and persons in visited houses may refuse to permit the reading of integrating meters. Furthermore, meter reading centers require a large amount of manpower leading to many expenses, to process numerical data recorded by metermen using computers.

In particular, for power consumption, the amount of load power varies every moment and reserve power must be used to meet a demanded amount of power when the maximum load power is applied. Notably, to increase reserve power by 1% necessitates a national enormous investment. In this regard a charge-by-time system is required to fix a high power, rate in the maximum load power time zone and a low power rate in the minimum load power time zone, for example, the night time, in turn resulting in a need for the development of remote meter reading units.

In order to meet this requirement, a large number of remote meter reading units have been developed. These meter reading units may be, for example, a direct meter reading unit and an automatic meter reading (AMR) unit. The direct meter reading unit comprises a plurality of sensors instead of a conventional wheel structure on which a numerical value is recorded. The sensors are used to record a read numerical value. The ANIR unit comprises sensor means including analog and digital circuits for converting physical and electrical amounts varying every moment into electrical pulses. The sensor means has a variety of sensors, such as a photosensor, maonetometric sensor, hall sensor, etc. which are provided on a rotating member of an integrating meter, such as a rotating disc or rotating drum, and the body of the meter. This AMR unit is adapted to continuously integrate numerical values and automatically transmit the integrated data upon receiving a meter reading request.

In order to efficiently and economically perform the remote meter reading operation it is necessary to provide synthetic meter reading means capable of synthetically reading all types of integrating meters including water meters, gas meters hot water meters and the like as well as electric power meters. However, enormous development expenses and a lengthy period of time are required in constructing or modifying the same remote meter reading unit to install it in meters of different types, different capacities, different specifications and different systems.

Further, external factors such as a flash of lighting, power surge, etc. may adversely affect the reliability and stability of meters. For example, such factors may damage circuits of meters. For this reason meters must be verified for reliability and stability. However, a great cost and a large amounts of time are usually required in performing such a verification.

Moreover, integrating meters may be demonstratively installed for the testing of the remote meter reading operation. However, water meters and gas meters themselves are high in price and furthermore higher in installation cost, resulting in a considerable financial burden for their replacement with new ones. It is also impossible for conventional remote meter reading units to perform the remote meter reading operation for a lengthy period of time using batteries.

Furthermore, when a remote meter reading function fails, a manual meter reading operation must be performed and no misreading of read values must occur during the reading operation For the purpose of overcoming these problems and the above problem with the replacement installation, a remote meter reading module comprising a sensor attached to an existing meter is disclosed in Korean Patent Publication No. 1994-4879. However, this meter reading module is disadvantageous in that the body of the meter must be modified for installation of the module therein, resulting in reductions in reliability and stability and an increase in cost.

On the other hand, various approaches have been proposed for the transmission and reception of data between automatic meter reading terminals and meter reading centers. In particular, a radio frequency (RF) system has been developed to solve an installation cost and management cost of a wired line, which is the most remarkable disadvantage of a wired system. However, in this RF system, a meter continuously consumes power because it updates an integrated value every moment. For this reason, the meter must comprise a separate power source or battery. For a gas or water meter depending on a battery, a meterman has to visit periodically (for example, every three to six months) for replacement of the battery due to the continuous power consumption.

### DISCLOSURE OF THE INVENTION

Therefore, the present invention has been made in view of the above problems, and it is an object of the present invention to provide a system and method for wireless automatic meter reading which can wirelessly and remotely read integrated amounts of consumed electric power, water, gas and the like.

It is another object of the present invention to provide a system and method for wireless automatic meter reading which is capable of being simply attached or mounted to the meters to perform a wireless remote reading operation.

It is a further object of the present invention to provide a system and method for wireless automatic meter reading which is mountable to all types of integrating meters including electric power meters, water meters, gas meters and the like to wirelessly and remotely read integrated amounts from the integrating meters.

It is a further object of the present invention to provide a system and method for wireless automatic meter reading wherein the integrating meters need not be verified for reliability and stability.

It is a further object of the present invention to provide a system and method for wireless automatic meter reading which can perform a wireless remote reading operation without modifying the bodies of the integrating meters.

It is a further object of the present invention to provide a system and method for wireless automatic meter reading which can minimize power consumption of a battery to perform a wireless remote reading operation for a maximized battery lifetime (for example, two to five years).

It is a further object of the present invention to provide a system and method for wireless automatic meter reading which can employ a self-induced current source, a solar cell or an organic electrolyte solar cell as a battery, resulting in no necessity for replacing the battery.

It is a further object of the present invention to provide a system and method for wireless automatic meter reading which can temporarily store integrated values by time zones and then transmit the stored values wirelessly.

It is a further object of the present invention to provide a system and method for wireless automatic meter reading wherein numerals of the integrating meters are not hidden so that a manual reading operation can be performed when a wireless remote reading function fails.

It is another object of the present invention to provide a system and method for wireless automatic meter reading which can unify integrated amounts of a group of integrating meters into one data unit and transmit the integrated data unit over one communication line, thereby significantly reducing an occupancy duration and communication amount of the communication line.

It is yet another object of the present invention to provide a system and method for wireless automatic meter reading which can transmit and receive data necessary to a wireless remote reading operation over power line communication, thereby performing the wireless remote reading operation irrespective of the positions of the integrating meters.

In accordance with one aspect of the present invention, the above and other objects can be accomplished by the provision of a system for wirelessly and remotely reading an integrating meter, comprising an image sensor module installed in a predetermined portion of the integrating meter for scanning a display of the meter, the image sensor module including an image sensor for picking up an image of a numeral displayed on the display and converting the picked-up image into an electrical signal; a dynamic random access memory for storing data of the numeral image picked-up by the image sensor; a digital signal processor for performing a preprocessing operation for the numeral image data stored in the dynamic random access memory to extract only components necessary to numeral recognition therefrom a main processor unit for comparing data extracted by the digital signal processor with a recognition library stored in an electrically erasable and programmable read only, memory, generating a numeric code corresponding to the numeral image in accordance with the compared result and storing the generated numeric code in a flash read only memory; a radio frequency module for transmitting numeric code data stored in the flash read only memory and/or code data of a numeral currently displayed on the display to a meter reading center for a predetermined period of time and receiving a command from the meter reading center: a synchronous time controller for performing a sleep mode operation in a normal state and, only when the current time is in accord with a timing code of the command received by the radio frequency module, supplying power from a power supply to an optical character reader module and the radio frequency module to minimize power consumption; and the meter reading center adapted for receiving and processing the numeric code data transmitted by the radio frequency module and transmitting the timing code to the radio frequency module for execution of a wireless remote reading operation.

Preferably, the image sensor module may be mounted at a predetermined portion outside a casing of the integrating meter while being spaced apart from the casing at a certain distance. As an alternative, the image sensor module may be mounted at a predetermined portion outside a transparent window of the integrating meter. In this case, the image sensor may be a transparent plate image sensor composed of a plastic polymer transistor such that a meterman can view the interior of the integrating meter so as to perform a manual meter reading operation.

Alternatively, the image sensor module may be installed in a bottom wall of the integrating meter at a predetermined portion above or under the display and a transparent body may be installed between the display and the image sensor module to refract the image of the numeral displayed on the display and transmit the refracted image to the image sensor module.

Preferably, the transparent body may have a cylindrical, shape a right triangular shape with its edges rounded, a right-angled triangular shape and a prism shape.

In another embodiment the image sensor module and the transparent body may be formed integrally with each other and in close proximity to each other. In this case, the image sensor may be a transparent plate image sensor composed of a plastic polymer transistor, such that a meterman can view the interior of the integrating meter so as to perform a manual meter reading operation.

In a further embodiment the image sensor module may be attached on an internal or external surface of a casing or transparent window of the integrating meter or mounted to the casing or transparent window of the integrating meter via a hole. Alternatively, the image sensor module may be attached on an internal surface of a protective casing or container of the integrating meter.

In yet another embodiment, the image sensor module may be attached on an external surface of a protective casing or container of the integrating meter mounted via a hole to the protective casing or container of the integrating meter or attached on an external surface of a casing or transparent window of the integrating meter such that it moves telescopically toward the display.

Preferably, the radio frequency module may include a master radio frequency module and a plurality of slave radio frequency modules within a given area, the master radio frequency module and the slave radio frequency modules transmitting and receiving data therebetween on the basis of their identification codes, the master radio frequency module transmitting and receiving data to/from the meter reading center on the basis of its identification code, thereby significantly reducing an occupancy duration and communication amount of a communication line.

Preferably, the radio frequency module may be a radio pico cell module or bluetooth module.

On the other hand, a two-way data transmission/reception terminal, such as an interactive pager or a two-way messenger, may be provided to perform the transmission and reception of data between the radio frequency module and the meter reading center. As an alternative a data network-based cellemetry system such as a personal communication service system, a code division multiple access system, a time division multiple access system or a global system for mobile communication, may be provided to perform the transmission and reception of data between the radio frequency module and the meter reading center.

Preferably, the optical character reader module and the image sensor module may be integrated into a one-chip unit, thereby making it easy to install and manage the system.

Preferably, power line communication means may be provided to transmit and receive data between the image sensor module and the radio frequency module over a power line when the integrating meter is installed in a communication dead zone. More preferably, the power line communication line may include a pair of induction coils connected to the power line or a pair of capacitors connected to the power line.

Preferably, the power supply may include a replaceable battery, a transparent solar cell, an organic electrolyte solar cell or an induced current source.

In accordance with another aspect of the present invention, there is provided a method for wirelessly and remotely reading an integrating meter, comprising the steps of a) picking up an image of a numeral displayed on a display of the integrating meter and converting the picked-up image into an electrical signal; b) storing data of the picked-up numeral image in a dynamic random access memory; c) performing a preprocessing operation for the numeral image data stored in the dynamic random access memory to extract only components necessary numeral recognition therefrom, d) comparing the extracted data with a recognition library stored in an electrically erasable and programmable read only memory, generating a numeric code corresponding to the numeral image data in accordance with the compared result and storing the generated numeric code in a flash read only memory: e) transmitting numeric; code data stored in the flash read only memory and/or code data of a numeral currently displayed on the display to a meter reading center via a radio frequency module for a predetermined period of time; and f) receiving and processing the numeric code data transmitted via the radio frequency module.

Preferably, the numeric code data may be temporarily stored in the flash read only memory prior to its transmission to the meter reading center.

The meter reading center may transmit a command to the integrating meter, the command including a command code for instructing the integrating meter to perform an image pickup operation and an identification code for designating the integrating meter. On the other hand, the numeric code data transmitted to the meter reading center via the radio frequency module may include numeric data regarding an integrated amount and an identification code indicative of the integrating meter.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a system and method for wireless automatic meter reading in accordance with a preferred embodiment of the present invention;

FIGS. 2a to 2e are perspective views of various embodiments of an image sensor module in FIG. 1;

FIGS. 3a to 3d are sectional views of various embodiments of a transparent body in FIG. 2d;

FIGS. 4a to 4c are views showing various embodiments of a power supply in accordance with the present invention;

FIG. 5 is a schematic view illustrating a communication relation between an integrating meter installed in a dead zone and a radio frequency module;

FIGS. 6a and 6b are schematic circuit diagrams illustrating different embodiments of a power communication system in FIG. 5;

FIG. 7 is a block diagram showing the construction of a system and method for wireless automatic meter reading in accordance with an alternative embodiment of the present invention; and

FIG. 8 is a flowchart illustrating the operation of the wireless remote reading system for the integrating meter in accordance with the present invention.

### BEST MODE FOR CARRYING OUT THE INVENTION

The present invention provides a wireless remote reading system for an integrating meter comprising an image preprocessor, a processor for reading identification and data codes a small-sized optical character reader module including a one-chip memory for the processing of mass data, and a time controller having a normal sleep function for minimizing power consumption.

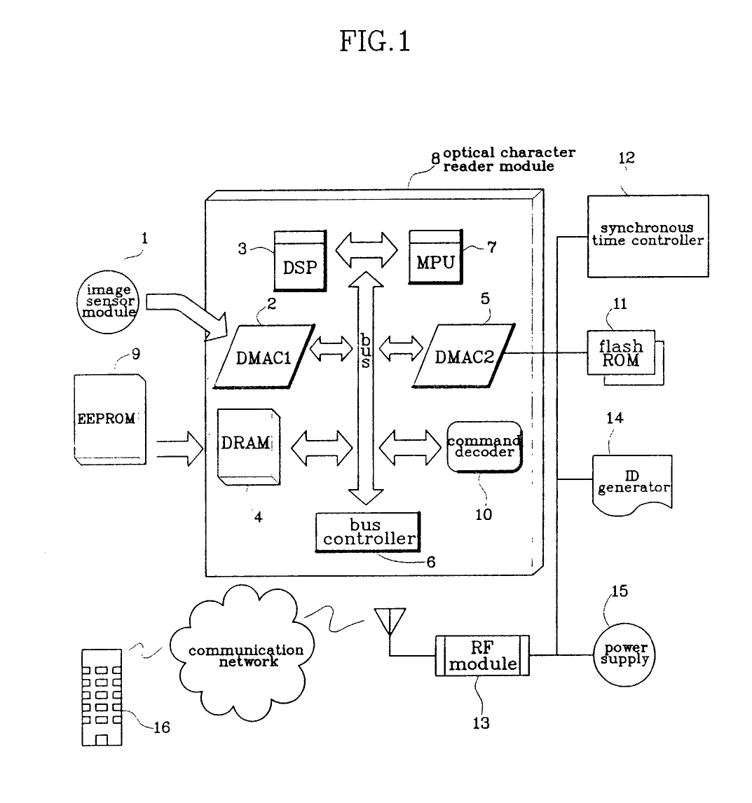

With reference to FIG. 1, there is shown in block form the construction of a wireless remote reading system for an integrating meter in accordance with a preferred embodiment of the present invention. As shown in this drawing the wireless remote reading system comprises an image sensor module 1 fixedly installed in a predetermined portion of the top wall or bottom wall of the integrating meter for sensing an image of a numeral on a display of the meter and converting the sensed image into an electrical signal.

The image sensor module 1 includes a solid-state image sensor for picking up an image and, converting the picked-up image into an electrical signal. The solid-state image sensor may preferably be a charge coupled device (CCD) image sensor a bucket brigade device (BBD) image sensor, a plasma coupled device (PCD) image sensor, a complementary metal-oxide semiconductor (CMOS) image sensor or a transparent plate image sensor composed of a plastic polymer transistor. The image sensor module 1 is installed in the top wall or bottom wall of the integrating meter at such a position that a meterman can personally read a numeral on the display with the naked eye. Alternatively, the image sensor module 1 may be made of a transparent material such that a meterman can personally read the numeral on the display with the naked eye irrespective of the installed position of the image sensor module 1.

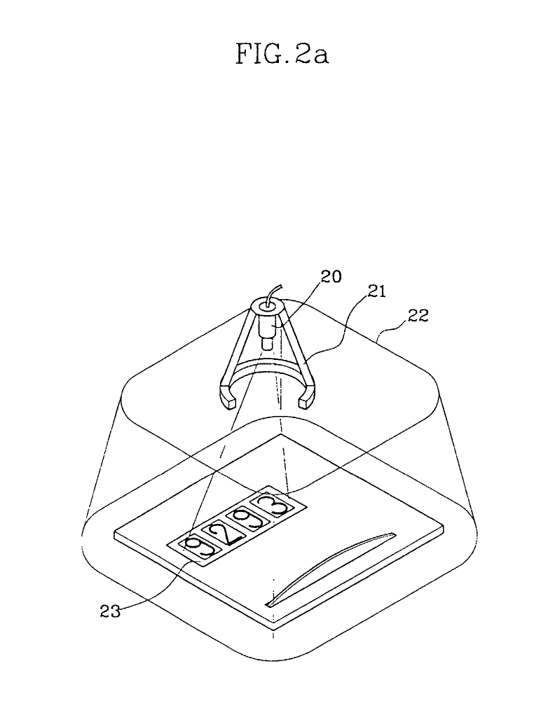

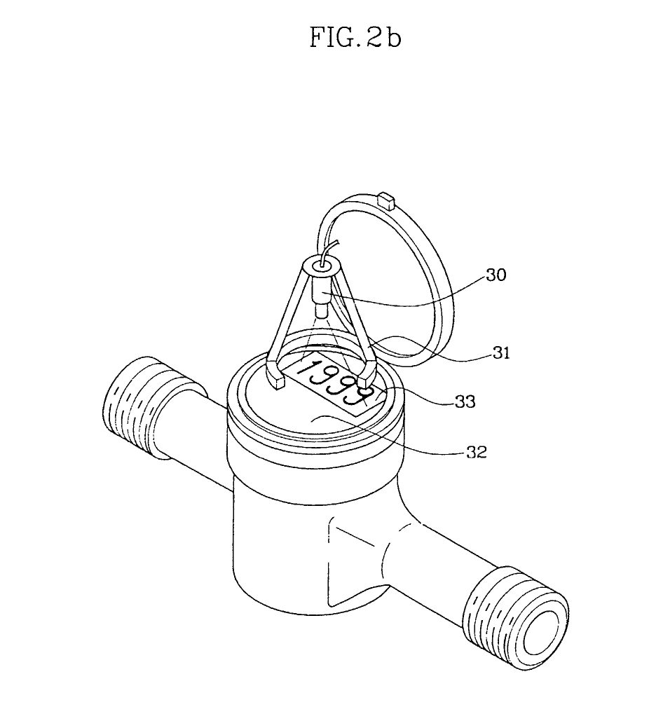

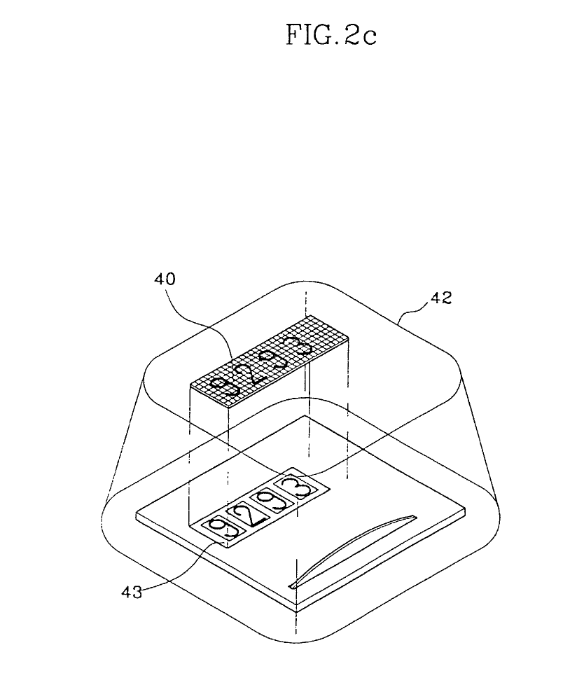

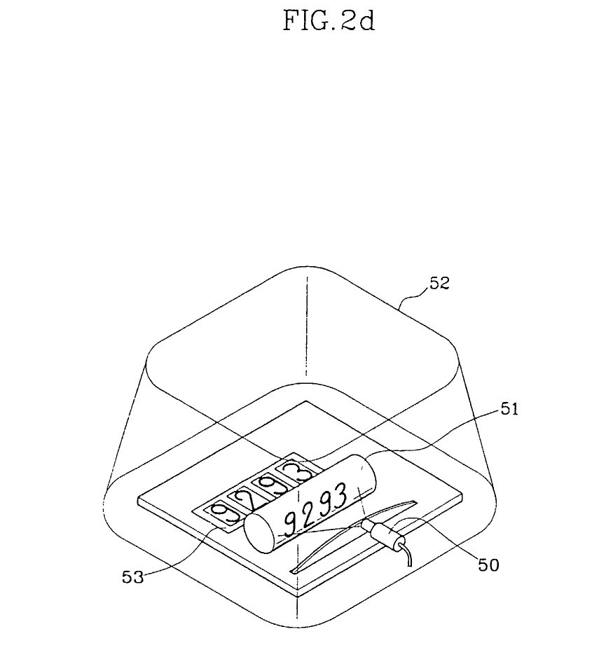

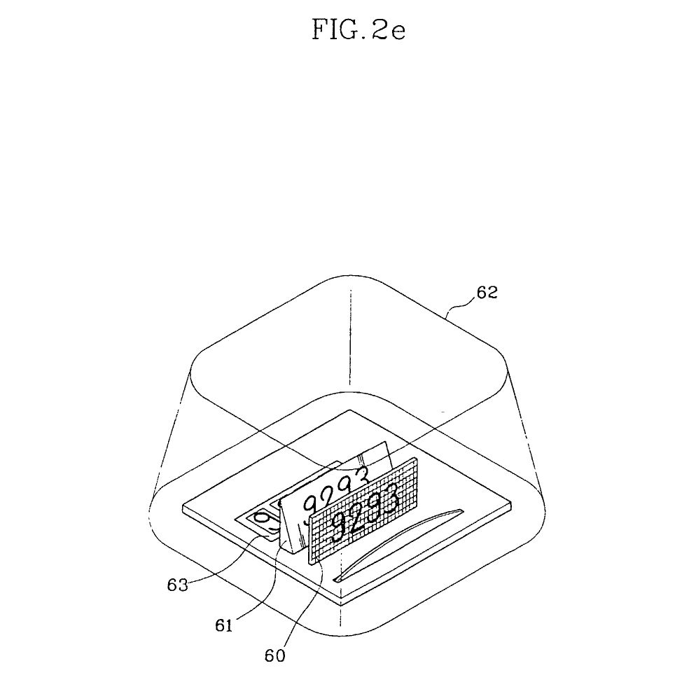

The image sensor module can be installed in integrating meters, such as electric power meters, water meters, gas meters and the like in various ways as shown in FIGS. 2a to 2e. For example, the image sensor module may be attached on the internal surface or external surface of a cover or casing of an integrating meter or mounted to the meter cover or casing via a hole. Alternatively, the image sensor module may be installed in a predetermined portion of the integrating meter while being neither attached nor mounted on the cover or casing of the meter but spaced apart therefrom at a certain distance.

FIG. 2a shows the structure of an image sensor module 20 mounted at a predetermined portion outside a transparent casing 22 of an electric power meter while being spaced apart from the casing 22 at a certain distance, and FIG. 2b shows the structure of an image sensor module 30 mounted at a predetermined portion outside a transparent window 32 of a water or gas meter while being spaced apart from the window 32 at a certain distance. A fixing member 21 or 31 is attached to the transparent casing 22 of the electric power meter or the transparent window of the water or gas meter, and the image sensor module 20 or 30 is mounted to the top of the fixing member 21 or 31 in such a manner that it can pick up an image of a numeral on a display 23 or 33 of the power meter or the water or gas meter.

As shown in FIG. 2c, an image sensor module 40, which includes a transparent plate image sensor composed of a plastic polymer transistor, may be attached directly to a transparent casing 42 or transparent window of an integrating meter to pick up an image of a numeral on a display 43 of the meter. This arrangement is made to prevent the image sensor module 40 from being externally 13 projected. Further, the image sensor module 40 is transparent not to hide the display 43. thereby making it easy to perform a manual meter reading operation when the wireless remote meter reading function fails. As an alternative, the image sensor module may be installed in the integrating meter at such a position that it does not hide the display. In this case, similarly, the manual meter reading operation can be performed easily at any time when the wireless remote meter reading function fails.

FIG. 2d shows the structure of an image sensor module 50 installed in the bottom wall of an integrating meter at a predetermined portion inside a casing or transparent window of the meter for picking up a refracted numeral image. A transparent body 51 with a desired shape is attached on the bottom wall of the integrating meter at a predetermined portion under a display 53, and the image sensor module 50 is installed in the bottom wall of the integrating meter at a predetermined portion spaced apart from the transparent body 51 at a certain distance to pick up a numeral image projected on the body 51. In other words, the image sensor module of the present invention can pick up a numeral image on the display 53 even within the casing of the integrating meter.

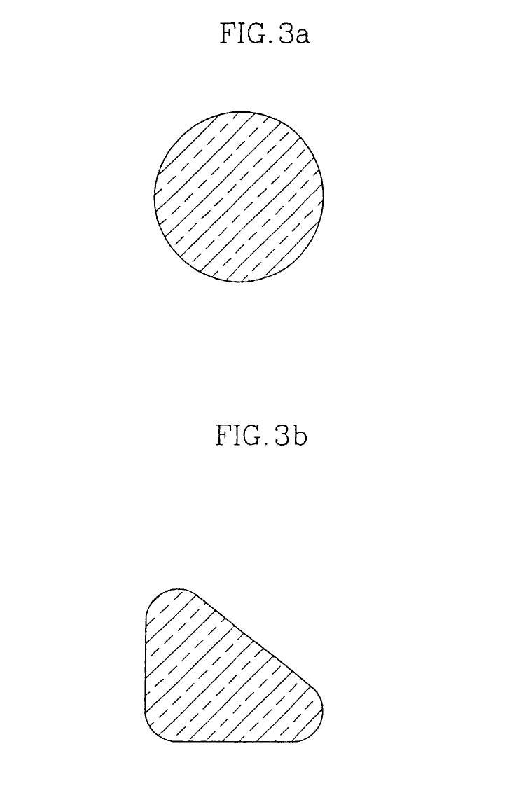

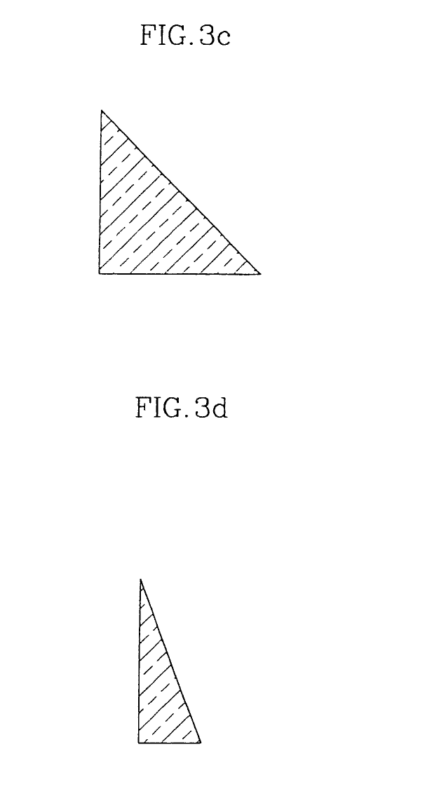

The transparent body 51, which refracts a numeral image on the display 53. may have a variety of shapes, for example, a cylindrical shape as shown in FIG. 3a, a right triangular shape with its edges rounded as shown in FIG. 3b, a typical right-angled triangular shape as shown in FIG. 3c land a prism shape as shown in FIG. 3d. For the right angled triangular transparent body an angle of inclination of the sloping side relative to the base must be set in consideration of a refraction angle.

The transparent body 61 having the prism shape as shown in FIG. 3d is applicable to a transparent plate image sensor module 60 as shown in FIG. 2e. In this case, the transparent body 61 and the transparent plate image sensor module 60 may be implemented in a single unit, as shown in FIG. 2e, because the image sensor module 60 is able to pick up a numeral image projected on the body 61 in close proximity to the body 61. This implementation is applicable to an integrating meter wherein a display 63 and a casing 62 are spaced apart from each other at a narrow interval, in that it can minimize the distance between the transparent body 61 and the transparent plate image sensor module 60.

Referring again to FIG. 1, a first data memory access controller (DMAC) 2 is adapted to store digital image data corresponding to an electrical image signal from the image sensor module 1 in a dynamic random access memory (DRAM) 4 and transfer the stored digital image data to a digital signal processor (DSP) 3 for image preprocessing. The first DMAC 2 is further adapted to store the results processed by the DSP 3 in the DRAM 4. Namely, the first DMAC 2 controls the input and output of data to/from the DRAM 4 via a bus. A second DMAC 5 functions to control the input and output of data between a radio frequency (RF) module 13 and a main processor unit (MPU) 7.

The DSP 3 is adapted to perform a preprocessing operation for the digital image data transferred by the first DMAC 2 so that the transferred digital image data can be recognized as a numeral. Namely, the DSP 3 removes noise components from the received digital image data and rapidly and effectively calculates the resulting digital image data to extract a shape, line segments and coordinate values; necessary to numeral recognition therefrom. Then, the DSP 3 stores the calculated results in the DRAM 40 under the control of the first DMAC 2. A bus controller 6 is connected to the bus to control an internal data transfer rate.

An optical character reader module 8, which recognizes numerals from a numeral image signal inputted through the image sensor module 1 and generates corresponding numeral codes, includes the DSP 3, the MPU 7 and the large-scale DRAM 4.

The DRAM 4 is adapted to store and output the digital image data corresponding to the electrical image signal from the image sensor module 1. The DRAM 4 is further adapted to store the result data from the DSP 3, load a recognition algorithm coded in an electrically erasable and programmable read only memory (EEPROM) 9 therein and output the stored result data and the loaded recognition algorithm to the MPU 7 for recognition calculation of the digital image data. Namely, the DRAM 4 supports the image sensor module 1, the DSP 3 and the MPU 7 in common.

Software with a high recognition rate is programmed in a desktop computer and then transferred to the EEPROM 9 in a hardware coding manner. The EEPROM 9 is an external nonvolatile memory acting to transfer a program stored therein to the DRAM 4 in response to a request from the MPU 7.

A flash ROM 11 acts to store an integrated numeral, recognized and encoded by the MPU 7, under the control of the second DMAC 5. The flash ROM. 11 further stores information, transmitted from a meter reading center 16 and decoded by a command decoder 10, and transfers the stored information to a synchronous time controller 12. Namely, the flash ROM 11 stores an identification (ID) code, meter reading time information and an integrated numeric code and transfers them to the RF module (for example, a radio pico cell module or bluetooth module) 13 in response to a transmission request.

The MPU 7 is adapted to perform a calculation operation for the results processed by the DSP 3 and a recognition library, loaded from the EEPROM 9 to the DRAM 4, and encode the resulting recognition numeral. Further, the MPU 7 checks a synchronous time of the synchronous time controller 12, encodes a meter reading time in accordance with the checked result and stores the resulting meter reading time code in the flash ROM 11 via the command decoder 10.

The synchronous time controller 12 is adapted to control the time of supply of power from a power supply 15 to associated components, or the RF module 13 and optical character reader module 8, in response to a meter reading time code transmitted from the meter reading center 16, decoded by the command decoder 10. In other words, the synchronous time controller 12 is normally in a sleep mode to supply no power from the power supply 15, and proceeds to an awake mode upon receiving a meter reading time code transmitted from the meter reading center 16, to supply power from the power supply 15 to the optical character reader module 8 only for a time period (for example, one to two minutes) designated by the received meter reading time code. Also in the awake mode the synchronous time controller 12 supplies the power from the power supply 15 to the RF module 13 only for a time period (for example, one to two hours) designated by a received command code. Further, for accurate transmission and reception synchronization, the controller 12 sets the standard time to time information, transmitted from the meter reading center 16 to the RF module 13, and interacts with the MPU 7 to generate a meter read time code and transmit it to the meter reading center 16.

The command decoder 10 is adapted to decode codes from the MPU 7, RF module 13 and synchronous time controller 12 and store the decoded results in the flash ROM 11. An identification (ID) generator 14 is adapted to generate an ID code (including an address and ID number) of the associated integrating meter, thereby enabling the meter reading center 16 to accurately transmit numeric data wirelessly to a desired integrating meter.

Although in the embodiment of the present invention the command decoder 10 is described as being separately provided, it is desirable that all the functions of the command decoder 10 are implemented by the MPU 7.

The power supply 15 includes a rechargeable battery for supplying a drive voltage to the optical character reader module 8 and RF module 13. The rechargeable battery may preferably be a hydrogen battery or thin-film lithium battery. The synchronous time controller 12 automatically monitors the level of output power from the battery and the amount of charges stored on the battery. In the present invention, power is consumed only for the operation of the optical character reader module 8 for image recognition and the communication with the meter reading center 16. In this regard, the power supply 15 need not always remain “ON” and its life can thus be maintained for two to five years or more.

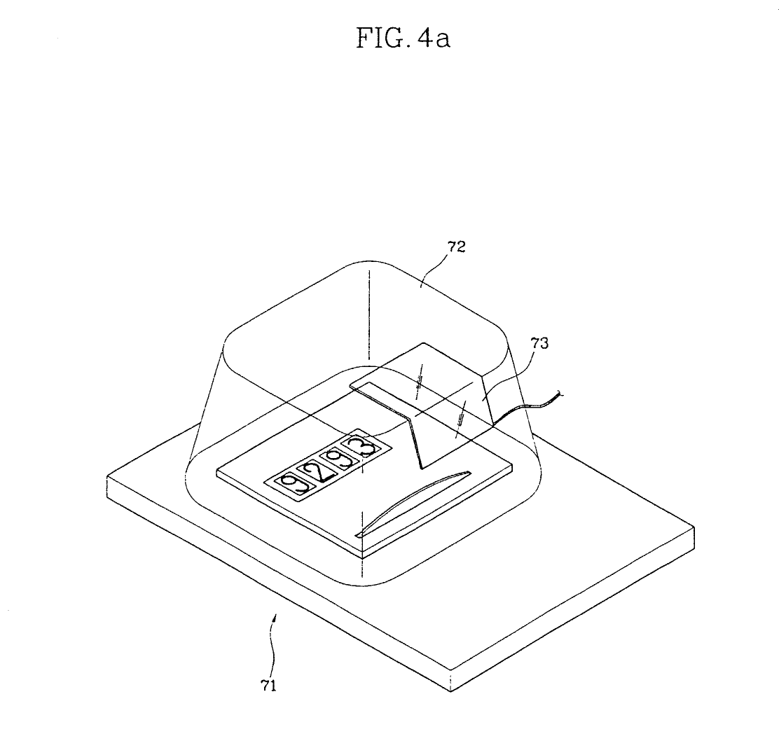

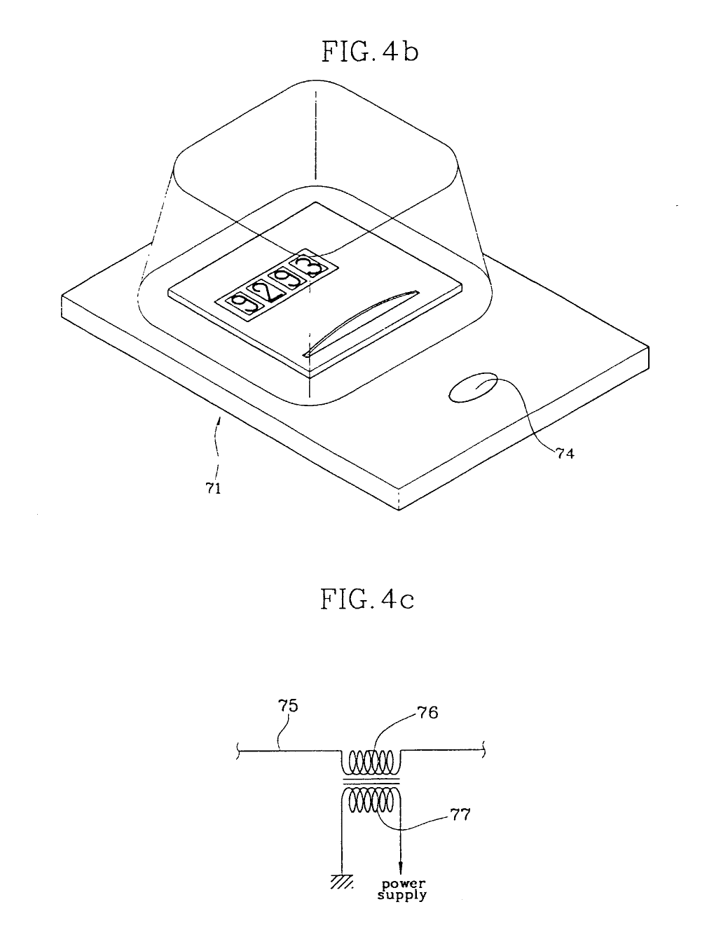

The power supply 15 includes a rechargeable and replaceable battery, as stated previously. Alternatively, the power supply 15 may include a transparent solar cell as shown in FIG. 4a, an organic electrolyte solar cell as shown in FIG. 4b or an induced current source as shown in FIG. 4c. That is, a transparent solar cell 73 may be attached on a casing 72 of an integrating meter 71, as shown in FIG. 4a, or an organic electrolyte solar cell 74 may be attached on a predetermined portion of the body of the integrating meter 71, as shown in FIG. 4b. In either case, the solar cell is suitable for an outdoor integrating meter in that it requires heat from the sun. Current may be induced in an induction coil 77 facing a coil 76 extending from a power line 75, as shown in FIG. 4c. This induced current is useable in spaces receiving no sunshine, such as underground, as well as outdoors.

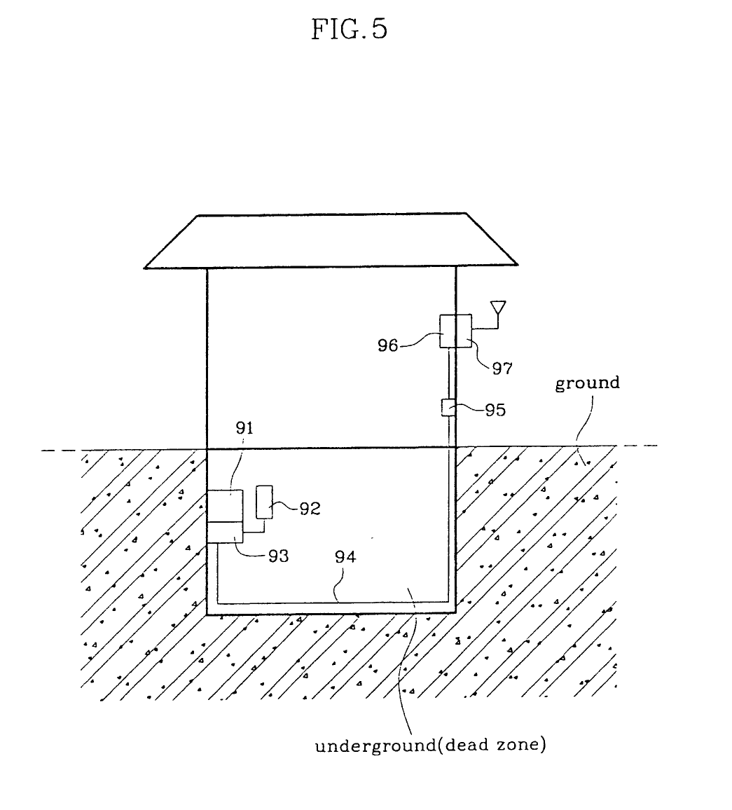

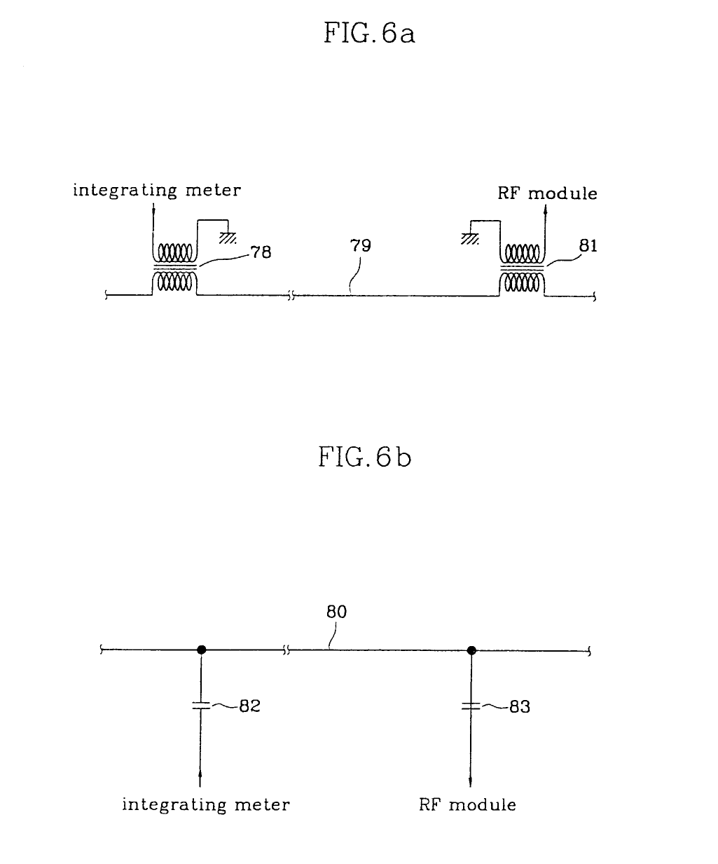

On the other hand, an integrating meter 91 may be installed in, a communication dead zone such as underground, as shown in FIG. 5. In this case, the integrating meter 91 can be connected to an outdoor RF module 97 over power line communication. The RF module 97 can transfer data between the integrating meter 91 and a meter reading center. To this end, a transmission module 93 must be provided in the integrating meter 91 including an image sensor module 92, and a reception module 96 must be provided in the RF module 97. The RF module 97 is coupled with a receptacle 95 of a power line 94 in such a way that it can readily be decoupled therefrom with no separate work. FIGS. 6a and 6b illustrate different embodiments of a power communication system for placing data regarding an integrated amount on a power line and extracting the data from the power line. In the power communication system of FIG. 6a, a pair of induction coils 78 and 81 connected to a power line 79 are installed respectively in an integrating meter and an RF module. Alternatively, in the power communication system of FIG. 6b, input and output terminals of an RF module and integrating meter are connected to a power line 80 respectively via capacitors 82 and 83. These two systems can selectively be used according to the conditions of an integrating meter and RF module.

In either system, a filter is provided to filter the integrated amount data transmitted over the power line communication, so as to prevent unnecessary components from being transmitted.

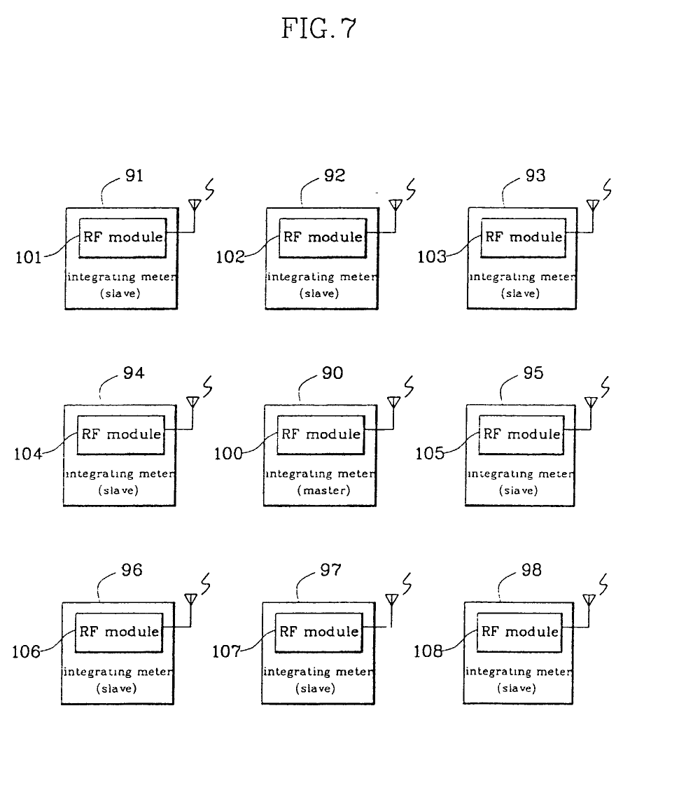

On the other hand, a plurality of integrating meters 90-98 may be grouped into a single unit in a given area, as shown in FIG. 7. In this case, image sensor modules and RF modules 100-108 paired therewith are installed respectively in the integrating meters in such a manner that one RF module 100 is a master and the other RF modules 101-108 are slaves. With this construction, the master RF module can unify numeric data regarding integrated amounts of the respective integrating meters and transmit the unified data to a meter reading center over one communication line.

Each RF module (for example, a bluetooth module or radio pico cell module) for data communication with the meter reading center acts to support a one-to-one or one-to-multiple wireless connection of an associated device to a variety of equipment existing within a given range. This RF module employs an industrial scientific medical (ISM) band of 2.4 GHz to provide a transmission rate of a maximum of 1 Mbps, a hop transceiver technology to reduce effects resulting from a fading interference, and a binary frequency modulation system.

This RF module can be provided in a variety of digital equipment including mobile telephones, notebooks, printers, desktop personal computers, personal digital assistants, facsimiles, keyboards, joysticks, etc. to perform voice and data, communications among the digital equipment using a radio frequency, not via a physical cable.

A two-way data transmission/reception terminal, such as an interactive pager or a two-way messenger (TWN), may be provided to perform the transmission and reception of data between the RF module and the meter reading center. As an alternative, a data network-based cellemetry system, such as a personal communication service (PCS) system, a code division multiple access (CDMA) system, a time division multiple access (TDMA) system or a global, system for mobile communication (GSM). may be provided to perform the transmission and reception of data between the RF module and the meter reading center.

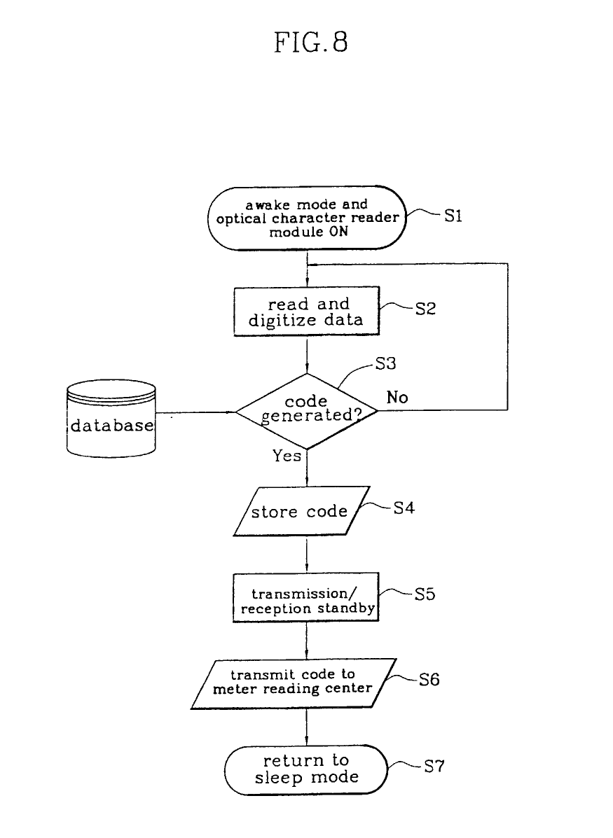

Next, a detailed description will be given of the operation of the wireless remote reading system with the above-stated construction in accordance with the present invention with reference to a flowchart of FIG. 8.

First, the synchronous time controller 12 in the integrating meter analyzes a meter reading command transmitted from the meter reading center 16. If the transmitted command is analyzed to command the change from the sleep mode to the awake mode, the synchronous time controller 12 controls the power supply 15 to supply power to the optical character reader module 8 in which a character recognition library is stored (S1).

The command transmitted from the meter reading center 16 includes a command code for instructing the associated integrating meter to perform an image pickup operation, and an ID code for designating the associated integrating meter. As a result, the meter reading center 16 can designate a specific integrating meter to be wirelessly and remotely read, by transmitting a specific command code to the meter.

Upon being energized by the power supply 15, the image sensor module 1 scans a numeral on the display of the integrating meter. Digital image data of the scanned numeral is stored in the DRAM 4 and then transferred to the DSP 3, which removes noise components from the transferred digital image data and performs a preprocessing operation for the resulting digital image data to extract a shape, line segments and coordinate values necessary to numeral recognition therefrom. Then, the DSP 3 digitizes the digital image data on the basis of the extracted shape, line segments and coordinate values (S2).

A recognition library stored in the EEPROM 9 is transferred to the MPU 7 via the DRAM 4. The MPU 7 compares the results processed by the DSP 3 with the recognition library loaded from the EEPROM 9, encodes the resulting recognition numeral and stores the resulting numeric code in the flash ROM 11 (S3). At the same time as storing the numeric code, the MPU 7 checks a meter reading time of the synchronous time controller 12 and stores the resulting meter reading time code and ID code in the flash ROM 11 (S4).

The synchronous time controller 12 checks a transmission code for data transmission and reception under the condition that the power supply 15 is in the sleep mode to maintain the optical character reader module 8 at its OFF state. At the moment that a standby time command code for data transmission and reception of the RF module 13 is in accord with a synchronous time, the synchronous time controller 12 controls the power supply 15 to maintain the RF module 13 at its ON state for a command time period. As a result, the RF module 13 remains at a transmission/reception standby state for the command time period (S5).

Upon receiving meter reading and transmission command codes from the meter reading center 16 at the transmission/reception standby state, the RF module 13 transmits the stored integrated numeric code or meter reading time code to the meter reading center 16 synchronously with a designated time (S6).

The numeric code, transmitted from the integrating meter to the meter reading center via the RF module includes numeric data regarding an integrated; amount and an ID code indicative of the integrating meter. As a result, the meter reading center analyzes the numeric code transmitted from the integrating meter and, in accordance with the analyzed result, not only calculates a rate of the integrated amount but also charges the calculated rate to a subscriber to which the integrating meter belongs.

Also, upon receiving a code signal from the meter reading center 16 at the standby state, the command decoder 10 decodes the received code signal and stores; the decoded result in the flash ROM 11. The synchronous time controller 12 waits for meter reading and transmission/reception command codes and synchronous time information from the meter reading center in the slip mode (S7).

Those skilled in the art will appreciate that the above-described wireless remote meter reading system and method are enough to accomplish the objects of the present invention.

### INDUSTRIAL APPLICABILITY

As apparent from the above description, the present invention provides a system and method for wireless automatic meter reading which can wirelessly and remotely read integrated amounts of consumed electric power, water, gas and the like. The wireless remote reading system is capable of being simply attached or mounted to the meters without replacing the meters with new ones, to perform a wireless remote reading operation. Further, numerals of the integrating meters are not hidden so that a manual reading operation can be performed at any time. The wireless remote reading system is mountable to all types of integrating meters including electric power meters, water meters, gas meters and the like to wirelessly and remotely read integrated amounts from the Integrating meters. Moreover, the wireless remote reading system need not be subjected to a verification for a lengthy period of time and the product thereof is small in size and low in cost.

Further, according to this invention, power is supplied only when the wireless remote reading operation is required, thereby lengthening the lifetime of, for example, a battery. Moreover, the wireless remote reading system can calculate local or national integrated amounts in a specific time zone, for example, the maximum load power time zone within a short time period and totally manage the integrated amounts. This has the effect of actively, rapidly and accurately coping with consumed amounts of electric power, water, gas and the like.

Furthermore, according to this invention, the wireless remote reading system can unify integrated amounts of a group of integrating meters into one data unit and transmit the unified data unit over one communication line, thereby significantly reducing an occupancy duration and communication amount of the communication line. Also, the wireless remote reading system can transmit and receive data necessary to the wireless remote reading operation over power line communication, thereby performing the wireless remote reading operation irrespective of the positions of the integrating meters.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. (Amended) A system for wirelessly and remotely reading an integrating meter, the integrating meter reading system having a user-side remote meter reading unit for receiving a meter value displayed on a display of the integrating meter in the form of an image, recognizing the meter value and wirelessly transmitting the meter value, and a meter reading center for receiving and processing numeric code data transmitted by the user-side remote meter reading unit and transmitting a timing code for execution of a wireless remote reading operation, the user-side remote meter reading unit comprising:
an image sensor module installed in a predetermined portion of said integrating meter for scanning the display of said meter, said image sensor module including an image sensor for picking up an image of a numeral displayed on said display and converting the picked-up image into an electrical signal;
an optical character reader module comprised of a dynamic random access memory for storing data of the numeral image picked-up by said image sensor a digital signal processor for performing a preprocessing operation for the numeral image data stored in said dynamic random access memory to extract only components necessary to numeral recognition therefrom, and a main processor unit for comparing data extracted by said digital signal processor with a recognition library stored in an electrically erasable and programmable read only memory, generating a numeric code corresponding to said numeral image in accordance with the compared result and storing the generated numeric code in a flash read only memory, and adapted to recognize the meter value picked up by the image sensor module;
a radio frequency module for transmitting numeric code data stored in said flash read only memory and/or code data of a numeral currently displayed on said display to the meter reading center for a predetermined period of time and receiving a command from said meter reading center; and
a synchronous time controller for performing a sleep mode operation at a normal state and, only when the current time is in accord with a timing code of the command received by said radio frequency module, supplying power from a power supply to the optical character reader module and said radio frequency module to minimize power consumption.

2. The system as set forth in claim 1, wherein said image sensor is a complementary metal-oxide semiconductor image sensor.

3. (Amended) The system as set forth in claim 1, wherein said image sensor module is installed in front of the display of said integrating meter while being spaced apart therefrom, and scans a numeral displayed on the display.

4. (Cancelled)

5. (Amended) The system as set forth in claim 4, wherein said image sensor is a transparent plate image sensor composed of a plastic polymer transistor and is attached to a casino or transparent window of the integrating meter at a predetermined position so as to allow the display of the integrating meter to be read with the naked eve.

6. (Amended) The system as set forth in claim 1, wherein said image sensor module further comprises a transparent body for refracting or reflecting the image of the numeral displayed on said display and transmitting the refracted or reflected image to said image sensor module so that the display of the integrating meter can be read with the naked eve.

7. (Amended) The system as set forth in claim 6, wherein said transparent body has a cylindrical shape, and installed beside the display of the integrated meter along a length of the display of the integrated meter.

8. (Amended) The system as set forth in claim 6, wherein said transparent body has a triangular prism shape, and installed beside the display of the integrated meter alone a length of the display of the integrated meter.

9. (Cancelled)

10. (Cancelled)

11. (Cancelled)

12. (Cancelled)

13. (Cancelled)

14. (Cancelled)

15. (Cancelled)

16. (Cancelled)

17. (Cancelled)

18. (Cancelled)

19. (Cancelled)

20. (Amended) The system as set forth in claim 1, wherein when two or more integrating meters and corresponding user-side remote meter reading units are installed within a given area, one of the user-side remote meter reading units is designated as a mater and the others thereof are designated as slaves, and the master remote meter reading unit directly communicates with the meter reading center and the slave remote meter reading units communicate with the meter reading center through the medium of the master remote meter reading unit.

21. The system as set forth in claim 1, wherein said radio frequency module is a radio pico cell module or bluetooth module.

22. The system as set forth in claim 1, further comprising two-way data transmission/reception means for performing the transmission and reception of data between said radio frequency module and said meter reading center, said two-way data transmission/reception means including an interactive pager or a two-way messenger.

23. The system as set forth in claim 1, further comprising data network-based cellemetry means for performing the transmission and reception of data between said radio frequency module and said meter reading center, said data network-based cellemetry means including a personal communication service system, a code division multiple access system, a time division multiple access system or a global system for mobile communication.

24. The system as set forth in claim 1, wherein said optical character reader module and said image sensor module are integrated into a one-chip unit.

25. (Amended) The system as set forth in claim 1, wherein when said integrating meter is installed in a communication dead zone, the image sensor module is installed in the integrating meter, the radio frequency module is installed in a communicatable zone and the data are transmitted and received between said image sensor module and said radio frequency module over a power line.

26. (Cancelled)

27. (Cancelled)

28. (Amended) The system as set forth in claim 1, wherein said power supply for supplying porter to the user-side remote meter reading unit is a replaceable battery.

29. (Amended) The system as set forth in claim 1, wherein said poster supply for supplying power to the user-side remote meter reading unit is a solar cell or organic electrolyte solar cell.

30. (Cancelled)

31. (Amended) The system as set forth in claim 1, wherein said power supplied to the user-side remote meter reading unit is current induced by an induction coil.

32. A method for wirelessly and remotely reading an integrating meter, comprising the steps of:
a) picking up an image of a numeral displayed on a display of said integrating meter and converting the picked-up image into an electrical signal;
b) storing data of the picked-up numeral image in a dynamic random access memory;
c) performing a preprocessing operation for the numeral image data stored in said dynamic random access memory to extract only components necessary to numeral recognition therefrom;
d) comparing the extracted data with a recognition library stored in an electrically erasable and programmable read only memory, generating a numeric code corresponding to said numeral image data in accordance with the compared result and storing the generated numeric code in a flash read only memory;
e) transmitting numeric code data stored in said flash read only memory and or code data of a numeral currently displayed on said display to a meter reading center via a radio frequency module for a predetermined period of time; and
f) receiving and processing said numeric code data transmitted via said radio frequency module.

33. The method as set forth in claim 32, wherein said numeric code data is temporarily stored in said flash read only memory prior to its transmission to said meter reading center.

34. The method as set forth in claim 32, wherein said meter reading center is adapted to transmit a command to said integrating meter, said command including a command code for instructing said integrating meter to perform an image pickup operation and an identification code for designating said integrating meter.

35. The method as set forth in claim 32, wherein said numeric code data transmitted to said meter reading center via said radio frequency module includes numeric data regarding an integrated amount and an identification code indicative of said integrating meter.
